(19) United States
(12) Patent Application Publication
(10) Pub. No.: US 2018/0130152 A1
(43) Pub. Date: May 10, 2018

(54) PROPERTY CHARACTERISTICS FILTERING TO AUTOMATICALLY UPDATE SUB-MARKETS FOR A SUBJECT PROPERTY

(71) Applicant: Fannie Mae, Washington, DC (US)

(72) Inventors: John Holbrook, Swanee, GA (US); Mark Brahler, Highlands Ranch, CO (US); Zaur Alekperov, Rockville, MD (US); David A. Talbird, Bronx, NY (US); Eric Rosenblatt, Derwood, MD (US); Timur Fatykhov, Silver Spring, MD (US)

(21) Appl. No.: 15/348,452

(22) Filed: Nov. 10, 2016

(51) Int. Cl. G06Q 50/16; G06Q 30/02

(52) U.S. Cl. CPC G06Q 50/16; G06Q 30/0278; G06Q 30/0205

(57) ABSTRACT

A subject property and a corresponding updatable pool of property sales are displayed in a map image. Property characteristics that define the pool of recent sales are manipulated using an interface that lists the characteristics and provides updatable ranges. Once a satisfactory set of ranges is established, the corresponding sub-market for the subject property is recalculated using only those properties that satisfy the new property characteristics criteria. A map image automatically updates to show those properties included in the updated pool, and those that were excluded. A model-based valuation also automatically updates and is listed among property data for the subject property.

### BACKGROUND OF THE INVENTION

### 1. Field of the Invention

This application relates to analysis of potential comparable properties for a subject property and more particularly to automatically updating a pool of recent sales as potential comparable properties for a subject property based upon filtered property characteristics, with a concurrently displayed automatically updating map image.

### 2. Description of the Related Art

Appraisals are traditionally performed by human appraisers who assess a subject property and apply various factors to identify a set of comparable properties against which the value of the subject property may be compared. The results may be described in an appraisal report listing the comparable properties.

Appraisals may be variously used in connection with transactions including loan approval as well as downstream transactions. Appraisal reports may be reviewed in connection with the approval of transactions. They may also be reviewed at other times, such as to assess the appraisal, to identify the possibility of a fraudulent transaction, or to assess the work of an appraiser. Traditionally, this might be performed by an assessor who reviews the report, perhaps does some investigation, and then assesses the results.

The traditional techniques for creating appraisals are inconsistent and incomplete. Automated valuation models have been developed to accommodate a review of comparable properties, as well as a valuation of a subject property, whether in an appraisal report or otherwise. Additionally, map images depicting properties have been implemented. However, use of such map images and corresponding valuations has tended to be limited to depicting an existing geographical area, along with whatever properties are found within that geographical area. This offers insufficient flexibility with respect to reviewing and assessing potential pools of comparable properties, for any given subject property.

What is needed are techniques for quickly and accurately reviewing pools of property sales as potential comparable properties for subject properties, and an improved ability to manipulate and update sub-markets of properties for subject properties, especially in the context of providing a tool for users to more easily create accurate and complete appraisals of subject properties.

### SUMMARY OF THE INVENTION

According to one aspect of this disclosure, a subject property and a corresponding updatable pool of property sales are displayed using property data and map imagery. This initially entails receiving an identification of a subject property, and then displaying a map image including a geographical area in which the subject property resides. The subject property is preferably displayed within the geographical area using a first graphical indicator to provide a visual distinction of its location on the map image. At the same time, an initial set of property sales is displayed within the geographical area using a second graphical indicator that is distinct from the first graphical indicator.

The pool of property sales can be filtered using an interface having various property characteristics and configurable ranges for those characteristics. First, a request to filter the property sales is received, and in response to receiving the request, the interface with the configurable property characteristic ranges appears alongside the map image depicting the property sales.

The interface is configured to receive input to alter the ranges of the various property characteristics. After receiving the updates, the pool of property sales is recalculated and the map image automatically updates to provide the revised showing of property sales. In one embodiment, a third indicator is used to illustrate those properties that have been removed from the current set of property sales.

In addition to the map image, a detailed listing of the property characteristics for the subject property and the current pool of property sales is displayed. These property characteristics include an automated valuation for the subject property based upon a current sub-market defined to include the current pool of property sales. When an update of the pool is generated as a result of changes to the ranges of property characteristics, the automated valuation for the subject property updates accordingly. This allows the user to readily review the impact of a variety of alterations of the property characteristics upon the generated valuation, which in turn helps to assess the quality of the pool for the subject.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are block diagrams illustrating examples of systems in which a comparable property analysis application operates.

FIG. 2 is a flow diagram illustrating an example of a process for updating a pool of property sales.

FIG. 3 is a flow diagram illustrating an example of a process for ranking and displaying property sales, with updates to the pool of potential comparables according to filtered property characteristics.

FIG. 4 is a block diagram illustrating an example of a comparable property analysis application.

FIG. 5A is a display diagram illustrating an example of a subject property, a map image and corresponding property grid data for a list of property sales as potential comparable properties.

FIG. 5B is a display diagram illustrating an example of a map image updated to include an interface with a filterable listing of property characteristics.

FIGS. 6A-C are respective display diagrams illustrating the interface before and after updates to the property characteristics filters.

FIG. 7 is a display diagram illustrating an example of a map image that has updated according to the generation of an updated pool of recent sales/potential comparables, following updates to the property characteristics filters.

FIGS. 8A-B are respective display diagrams illustrating an update to an automated valuation of a subject property following an update to the property characteristics filters and a corresponding change in the pool of potential comparables and the corresponding sub-market.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one aspect of this disclosure, a subject property and a corresponding updatable pool of recent property sales as potential comparable properties are displayed using property data and map imagery. An interface is configured to receive an identification of a subject property, and then to provide displays of map images including an updatable geographical area in which the subject property resides. The subject property is preferably displayed within the geographical area using a first graphical indicator to provide a visual distinction of its location on the map image. At the same time, property sales are displayed within the geographical area using a second graphical indicator that is distinct from the first graphical indicator.

The pool of property sales can be filtered using an interface having various property characteristics and configurable ranges for those characteristics. First, a request to filter the property sales is received, and in response to receiving the request, an interface with the configurable property characteristic ranges appears alongside the map image depicting the property sales.

The interface is configured to receive input to alter the ranges of the various property characteristics. After receiving the updates, the pool of property sales is recalculated and the map image automatically updates to provide the revised showing of property sales. In one embodiment, a third indicator is used to illustrate those properties that have been removed from the current set of property sales.

In addition to the map image, a detailed listing of the property characteristics for the subject property and the current pool of property sales is displayed. These property characteristics include an automated valuation for the subject property based upon a current sub-market defined to include the current pool of property sales. When an update of the pool is generated as a result of changes to the ranges of property characteristics, the valuation automatically updates according to the newly defined sub-market, along with an automatic update to the map image to distinctively show the subject property, the excluded properties, and the property sales remaining in the newly defined sub-market. This allows the user to readily review the impact of a variety of alterations of the property characteristics upon the generated valuation, both in terms of reviewing the map image and the corresponding property locations, as well as the corresponding valuation and other data. Along with this, each property may be selected for review and assessment as to the underlying data and other characteristics to further evaluate whether the property is a good comparable, and also whether the characteristics associated with that property are accurate and complete. All of these features help the user to assess and update the quality of the pool of potential comparables for the subject property. Still further, the user can review the map image and corresponding inclusion and exclusion of potential comparable properties. For example, the map image may readily show a property that is very close to the subject property (e.g., next door) that has been excluded in a filtering operation. That property can be reviewed (e.g., perhaps there is a data error in its characteristics) and if desired it can be re-introduced to the pool individually by the user.

Preferably, an automated valuation model is used to provide valuations for properties in the pool of potential comparable properties, including the contributions of characteristics to those valuations. The AVM provides an initial point of reference that allows the user to identify data errors and other reasons that a property may or may not be included in a currently filtered pool of properties. Various models may be implemented. In one example, the property data is accessed and a regression models the relationship between price and explanatory variables. For example, a hedonic regression is performed at a geographic level (e.g., county) sufficient to produce reliable results.

An initial determination (i.e., the starting point for a user's review) of a pool of recent sales may employ no exclusion rules. For example, in one embodiment the default pool may comprise a predetermined number of properties (e.g., 500) having sales data within a given period of time (e.g., one year) that are closest to the subject property in terms of physical distance. However, if desired, various default characteristics may be applied for the purpose of generating an initial pool of recent sales as potential comparables, such as by initial exclusion rules based upon factors other than distance from the subject property.

The AVM may also employ adjustments to comparables to further their evaluation. In the example of an AVM that uses hedonic regression, adjustments may be made using adjustment factors drawn from the regression analysis. Additionally, the AVM may generate comparison information such as economic distance between each comparable and the subject property. For example, the economic distance may be a value indicative of the estimated price difference between a comp and the subject that is determined from the set of adjustments for that comp. The comparables can be weighted according to the economic distance, physical distance and time (of sale) between the comparable and the subject property. This weighting can be used to determine ranked listings.

In connection with the display of listings of comparables, a map image is displayed to illustrate the geographic distribution of the subject property and the property sales. Thus, in addition to offering the ranked listing that indicates where among the ranking the comparables are listed, there is a concurrent display on the map image that gives an immediate indication of the location of the property sales. This allows further assessment as to general proximity between the comparables and the subject property, whether the comparables are in the same or a different neighborhood, and where the comparables are located with respect to significant features (highways, schools, bodies of water, etc.), etc.

An associated property data grid further details information about the subject and property sales. The grid operates in conjunction with the map image to ease review of the comparables and corresponding criteria. The map image may be variously scaled and updates to show the subject property and corresponding comparables in the viewed range, and interacts with the grid (e.g. cursor overlay on comparable property in the map image allows highlighting of additional data in the grid).

Various models may be used to generate automated valuations based upon updatable pools of property sales, including but not limited to one using a hedonic regression technique.

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. The explanatory variables are:

(1) Four continuous property characteristics:

(a) log of gross living area (GLA),

(b) log of Lot Size,

(c) log of Age, and

(d) Number of Bathrooms; and

(2) Three fixed effect variables:

(a) location fixed effect (e.g., by Census Block Group (CBG));

(b) Time fixed effect (e.g., measured by 3-month periods (quarters) counting back from the estimation date); and

(c) Foreclosure status fixed effect, which captures the maintenance condition and possible REO discount.

The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}}^{ } {FCL}_{k} + ɛ \qquad ( Eq . 1 )$$

The above equation is offered as an example, and as noted, there may be departures. For example, although CBG is used as the location fixed effect, other examples may include Census Tract or other units of geographical area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

As introduced above, a basic default set of comparables may implement little or no exclusion rules. However, as described further below, user interfaces are provided to filter property characteristics pursuant to an automatic update of a default pool (i.e., default sub-market) in order to create and render an updated pool (i.e., updated sub-market). Comparable selection rules are used to narrow or expand the pool of comps according to the filter characteristics.

Given the (default or updated) pool of comps, the sale price of each comp may then be adjusted to reflect the difference between a given comp and the subject in each of the characteristics used in the hedonic price equation.

For example, individual adjustments are given by the following set of equations (2):

i A_{gla}=exp[(ln(GLA_{S})−ln(GLA_{C}))·β_{gla}];

Aₗₒₜ=exp[(ln(LOT_{S})−ln(LOT_{C}))·βₗₒₜ];

A_{age}=exp[(ln(AGE_{S})−ln(AGE_{C}))·β_{age}];

A_{bath}=exp[(BATH_{S}−BATH_{C})·β_{age}];

A_{loc}=exp[LOC_{S}−LOC_{C}];

Aₜᵢₘₑ=exp[TIME_{S}=TIME_{C}]; and

A_{fcl}=exp[FCL_{S}−FCL_{C}],

where coefficients βgla, βlot, βage, βbath, LOC, TIME, FCL are obtained from the hedonic price equation described above. Hence, the adjusted price of the comparable sales is summarized as:

$${p}_{C}^{adj} = {p}_{C} \cdot {\prod }_{i ∈ \{ gla , lot , age , bath , loc , time , fcl \}} {A}_{i} = {p}_{C} \cdot {A}_{TOTAL} \qquad ( Eq . 3 )$$

Because of unknown neighborhood boundaries and potentially missing data, the initial pool of potential comparables will likely include more than are necessary for the best value prediction in most markets. The adjustments described above can be quite large given the differences between the subject property and potential comparable properties. Accordingly, rank ordering and weighting are also useful for the purpose of value prediction, and as one of the tools provided to the user in support of creating more well defined sub-markets for the subject property.

One example of information that may be used to rank the comparables is referred to as economic distance. The economic distance D_{eco} between the subject property and a given comp may be described as a function of the differences between them as measured in dollar value for a variety of characteristics, taking into account the property characteristics as well as other criteria such as the adjustment factors described above.

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , loc , time , fcl \}} {( {A}_{i} - 1 )}^{2}} \qquad ( Eq . 4 )$$

The comps can be weighted using this information. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {dT}_{SC}} \qquad ( Eq . 5 )$$

where D_{geo} is a measure of a geographic distance between the comp and the subject, defined as a piece-wise function:

$${D}_{SC}^{geo} = \{ \begin{matrix}0.1 & if {d}_{SC} < 0.1 mi \\ {d}_{SC} & if 0.1 mi \leq {d}_{SC} \leq 1.0 mi \\ 1.0 + \sqrt{{d}_{SC} - 1.0} & if {d}_{SC} > 1.0 mi\end{matrix} , \qquad ( Eq . 6 )$$

and dT is a down-weighting age of comp sale factor

$${dT}_{SC} = \{ \begin{matrix}1.00 & if ( 0 , 90 ] days \\ 1.25 & if ( 90 , 180 ] days \\ 2.00 & if ( 180 , 270 ] days \\ 2.50 & if ( 270 , 365 ] days\end{matrix} . \qquad ( Eq . 7 )$$

Comps with higher weight receive higher rank and consequently contribute more value to the final prediction, since the predicted value of the subject property based on comparable sales model is given by the weighted average of the adjusted price of all comps:

$${\hat{p}}_{S} = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 8 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

Optionally, the potential comparable properties may then be listed according to the weighting, or a ranking from the highest weighted comparable property to the lowest. This listing may be variously limited to accommodate listing them within a display area.

Mapping and analytical tools that implement the comparable model are provided. Mapping features allow the subject property and recent sales/potential comparable properties to be concurrently displayed, along with the grid of property data.

With further reference to the figures, examples of environments and particular embodiments implementing the generation of pools of property sales are now further described.

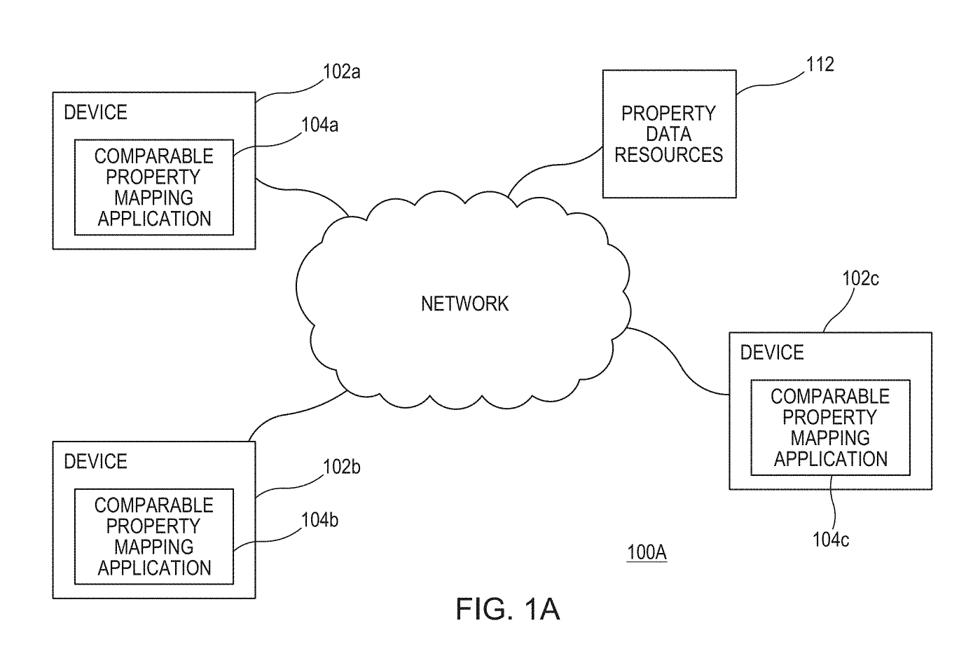

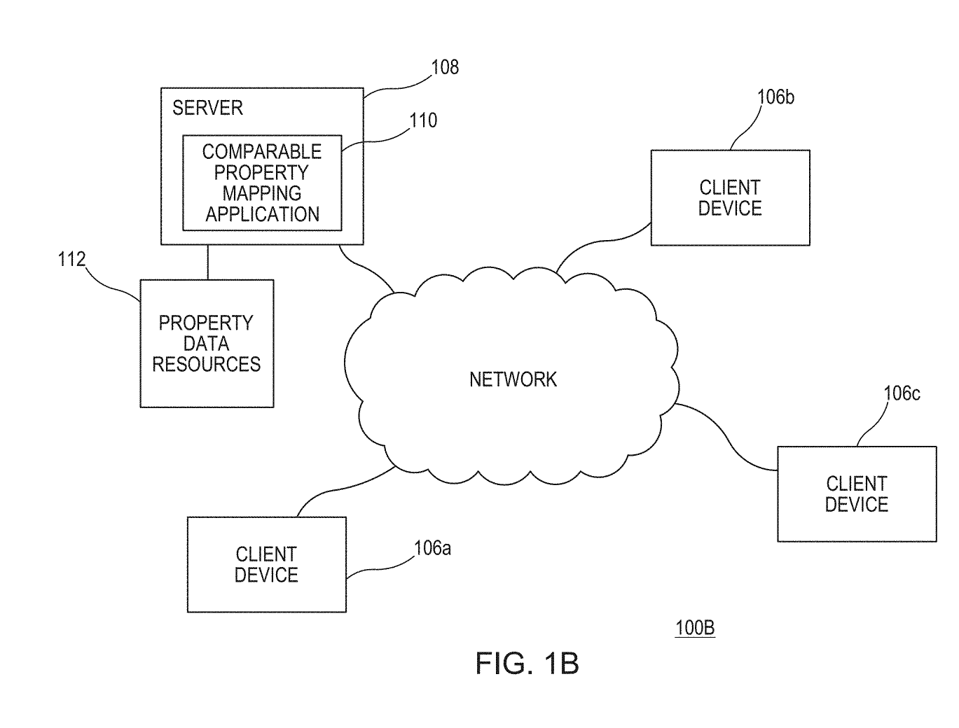

FIGS. 1A-B are block diagrams illustrating examples of systems 100A-B in which a comparable property analysis application operates.

FIG. 1A illustrates several user devices 102a-c each having a comparable property analysis application 104a-c.

The user devices 102a-d are preferably computer devices, which may be referred to as workstations, although they may be any conventional computing device. The network over which the devices 102a-d may communicate may also implement any conventional technology, including but not limited to cellular, WiFi, WLAN, LAN, or combinations thereof.

In one embodiment, the comparable property analysis application 104a-c is an application that is installed on the user device 102a-c. For example, the user device 102a-c may be configured with a web browser application, with the application configured to run in the context of the functionality of the browser application. This configuration may also implement a network architecture wherein the comparable property analysis applications 104a-c provide, share and rely upon the comparable property analysis application 104a-c functionality.

As an alternative, as illustrated in FIG. 1B, the computing devices 106a-c may respectively access a server 108, such as through conventional web browsing, with the server 108 providing the comparable property analysis application 110 for access by the client computing devices 106a-c. As another alternative, the functionality may be divided between the computing devices and server. Finally, of course, a single computing device may be independent configured to include the comparable property analysis application.

As illustrated in FIGS. 1A-B, property data resources 110 are typically accessed externally for use by the comparable property analysis application, since the amount of property data is rather voluminous, and since the application is configured to allow access to any county or local area in a very large geographical area (e.g., for an entire country such as the United States). Additionally, the property data resources 110 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property analysis application accesses and retrieves the property data from these resources in support of the modeling of comparable properties as well as the rendering of map images of subject properties and corresponding property sales, and the display of supportive data (e.g., in grid form) in association with the map images.

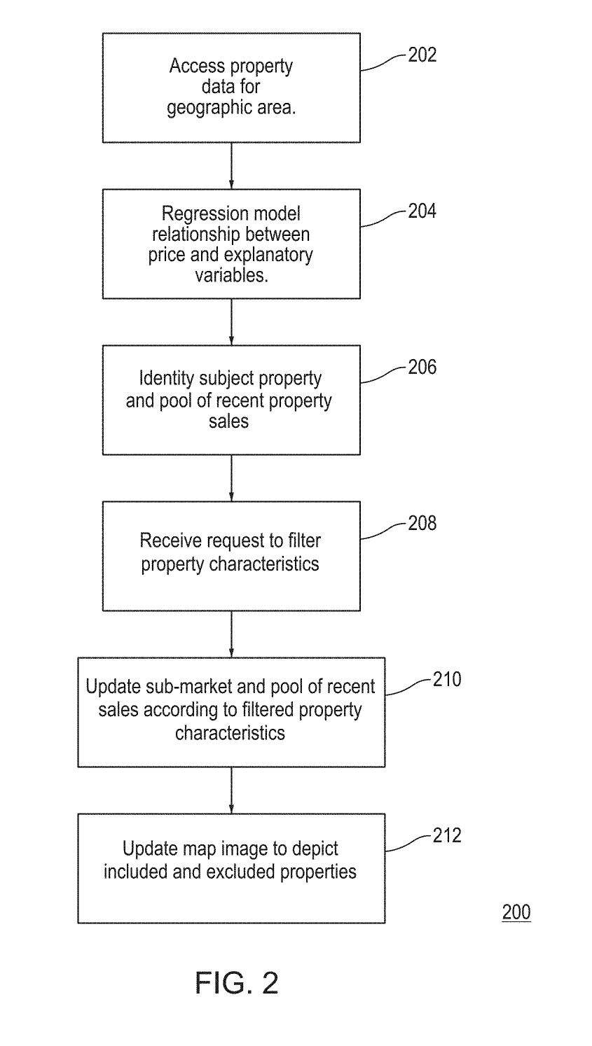

FIG. 2 is a flow diagram illustrating an example of a process 200 for updating a pool of property sales/potential comparable properties.

As has been described, the application accesses 202 property data. This is preferably tailored at an initial geographical area of interest in which a subject property is located (e.g., county). A regression 204 modeling the relationship between price and explanatory variables is performed on the accessed property data. Although various alternatives may be applied, a preferred regression is that described above, wherein the explanatory variables are the property characteristics (GLA, lot size, age, number of bathrooms) as well as the categorical fixed effects (location, time, foreclosure status).

A subject property within the county is identified 206 as is a pool of recent sales as potential comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of property sales for each particular subject property.

Typically, the closest properties (in physical distance) to the subject property define an initial pool of property sales that are potential comparables, such as the closest 500 properties. But the pool of property sales may be initially defined using some default exclusion rules, if desired.

Valuation may be carried out using adjustment factors for each comparable property. The adjustment factors may be a numerical representation of the price contribution of each of the explanatory variables, as determined from the difference between the subject property and the comparable property for a given explanatory variable. An example of the equations for determining these individual adjustments has been provided above. The listing of property sales can also be conveyed to the user in the form of grid and map image displays to allow convenient and comprehensive review and analysis of the set of comparables.

The application also includes interfaces for filtering property characteristics, and corresponding updates to the pool of property sales. This entails initially receiving 208 a request to filter the property characteristics that are used to include/exclude comparables from the pool. This request is preferably initiated by receipt of user input such as through a button that prompts display of a filtering interface having a list of property characteristics and corresponding updatable ranges. Updates to the ranges for various property characteristics can be applied through the interface, and once a user is satisfied with a new set of ranges, the user may submit the new ranges.

Upon receipt of this submission, the application updates 210 the corresponding pool of recent sales to be included in a sub-market analysis) according to the filtered property characteristics data. This entails the application of exclusion rules and an updating of the pool. Additionally, adjustments and valuations of the subject property and updated pool of potential comparables is performed.

With the updated information, the application updates 212 the display to alter the map image, as well as the listing of comparables. Preferably, the pool of property sales is indicated uniquely via an indicator such as a solid dot, to depict that they are within the current pool. Those property sales that were in a default set, but which were removed as a result of the filtering, may be indicated in alternative fashion, such as by a clear triangle. In this fashion, the user is given an indication of the reduction in the pool as a result of the filtering operation. Additionally, the listing of properties may be provided on the same display, along with any valuation updates resulting from the change in sub-market caused by the filtering.

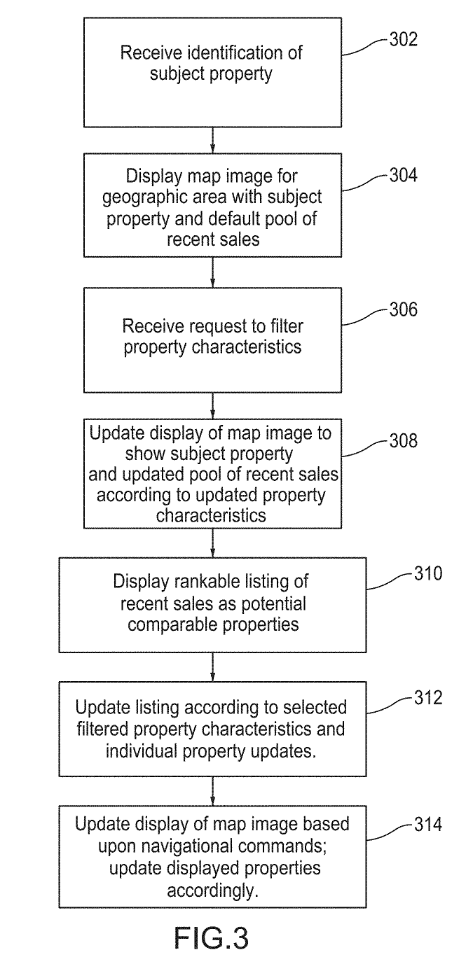

FIG. 3 is a flow diagram illustrating an example of a method 300 for displaying property sales, including updated valuation of property sales based upon newly defined sub-markets.

The method 300 may initiate with identification 302 of a subject property. This may be performed using a user interface that allows a user to input property identification information as a starting point to preparing an appraisal. Once the subject property is identified, the subject property and a corresponding default pool of recent sales as potential comparables may be displayed 304 on a map image with indicators showing the subject property and the locations of the recent sales. This map image may be acquired from conventional mapping resources, including but not limited to Google maps and the like. Additionally, conventional techniques may be used to depict subject and property sales on the map image, such as through determination of the coordinates from address information.

The map imagery may be updated to provide user-desired views, including zooming in and out to provide more narrow or broad perspectives of the depictions of the comparable and subject properties. In addition to the map image, a corresponding grid of comparative property data concerning the listed properties may be concurrently displayed.

The property data includes information as to the location of the properties, and either this native data may be used, or it may be supplemented, to acquire the exact location of the subject property and potential comparable properties on the map image. This allows the map image to be populated with indicators that display the location of the subject property and the potential comparable properties in visually distinguishable fashion on the map image. The number of property sales that are shown can be predetermined or may be configurable based upon user preferences. The number of property sales that are shown may also update depending upon the level of granularity of the map image. That is, when the user updates the map image such as by zooming out to encompass a wider geographical area, the map image automatically updates to depict additional property sales over those rendered at a more local range.

The user may also prompt a particular comparable property to be highlighted, such as by cursor rollover or selection of an entry for the comparable property in a listing. When the application receives an indication that a property has been selected, it is highlighted in the map. Conversely, the user may also select the indicator for a property on the map image, which causes display of the details corresponding to the selected property.

Once the default pool of potential comparables is provided, it may be updated according to various criteria. This may be initiated by a receiving 306 a request to filter property characteristics that are used to define a sub-market for the subject property. The initial set of property characteristics are set based upon the characteristics of the subject property, with default ranges defining included and excluded properties. An initial set of ranges provides relatively coarse filtering so as to include a reasonably large initial pool of potential comparables. User interfaces are provided to allow the user to change the ranges for the property characteristics. In one example, once the user is satisfied with a new set of property characteristics, a submit button or the like prompts an updated display 308 of the map image to show the subject property and an update to the current pool of recent sales/potential comparables according to the updated (filtered) property characteristics. The corresponding display 310 of underlying property characteristics for the property sales, as updated by the filtering of property characteristics, also automatically occurs at this time.

The AVM as described above works in conjunction with the updatable set of property characteristics in order to provide updates to at least some variables associates with the corresponding updatable pools of property sales. In one example, the model may be the described hedonic regression performed initially at a geographic level (e.g., county or CBG) sufficient to produce reliable results. As set forth in further detail above, the described model identifies a pool of potential comparables, determines adjustments for each comparable using adjustment factors drawn from the regression analysis, derives an economic distance between each comparable and the subject property, and can weigh the comparables according to the economic distance between the comparable and the subject property. This weighting can be used to determine a ranked listing, with the highest weighting being the closest-ranked comparable, and so on. However, the grid of property data may be variously manipulated by the user to provide alternative “rankings”. For example, the user might simply want to rank the properties on physical distance, or perhaps a characteristic like the number of bedrooms. The interface automatically updates the listing of properties so the user may freely assess the pool of property sales according to any desired criteria. At the same time, the AVM automatically updates its model-based valuation of the comparables.

Although the particulars of one model are described herein, it should be understood that alternative models may be implemented according to the present invention.

Still further, the ranked listing is updated 312 upon the receipt of changes to the filtered property characteristics. When this operation occurs, both the map image and the ranked listing are updated to display a new pool of property sales. Moreover, a new valuation for the subject property is indicated based upon the new pool of property sales. Additionally, the map image may be further updated to assess geographical areas at various levels of granularity (e.g., zoom in upon the neighborhood of the subject property, or zoom out to review potential comparable properties for a broader geographical area). The map image updates 314 accordingly, both as to the map image and the inclusion of indicators for the subject and property sales. Still further, any individual property may be reviewed and updated, including an operation to bring an individual property from excluded status into the current pool of recent sales for further consideration as a comparable. All updates to the individual property are tracked to allow subsequent analysis of the reasoning for changes and inclusion or exclusion from the pool of recent sales or as a comparable property. Additionally, the AVM provides valuation information useful for flagging potential data errors. A user may select any individual property and drill down as to the reasoning for individual property valuation. Odd results may prompt inspection and allow the identification of errors in the property data.

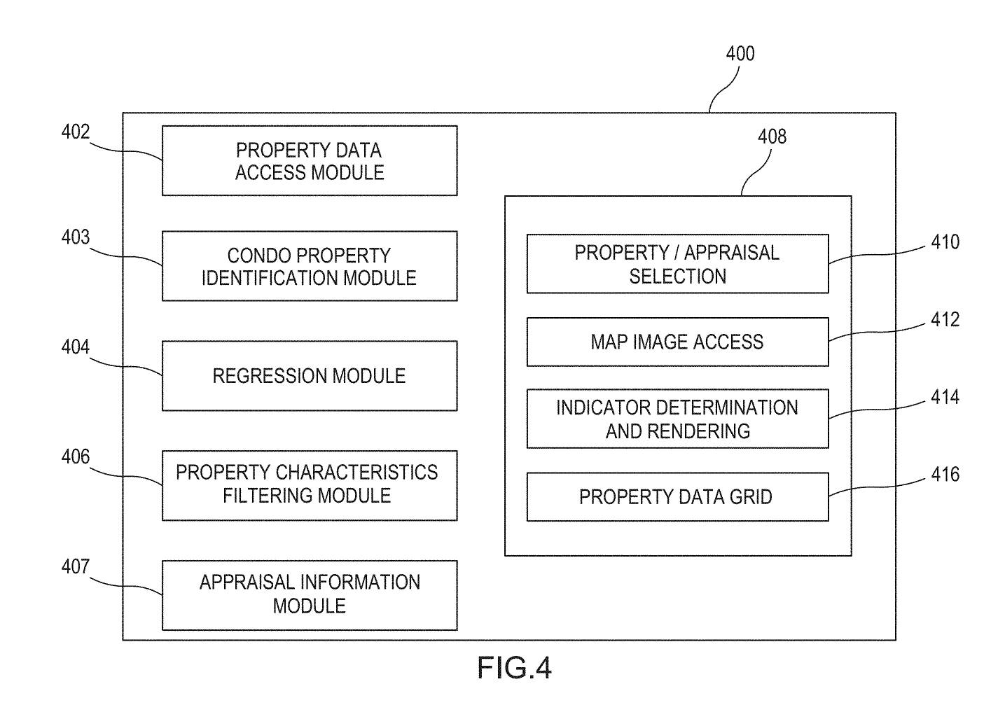

FIG. 4 is a block diagram illustrating an example of a comparable property analysis application 400. The application 400 preferably comprises program code that is stored on a computer readable medium (e.g., compact disk, hard disk, etc.) and that is executable by a processor to perform operations in support of modeling and mapping comparable properties.

According to one aspect, the application includes program code executable to perform operations of receiving an identification of a subject property; displaying a map image including a geographical area in which the subject property resides, the subject property being displayed within the geographical area using a first graphical indicator; displaying a first set of property sales within the geographical area using a second graphical indicator that is distinct from the first graphical indicator; receiving a request to filter the first set of property sales; responsive to receiving the request, concurrently displaying a listing of property characteristics alongside the map image, the listing of property characteristics being configured to receive changes in ranges corresponding to the property characteristics; receiving an altered range for at least one of the property characteristics from the listing of property characteristics; and automatically updating the map image to display a second set of property sales that differs from the first set of property sales in response to receiving the altered range.

The application is also configured such that the second set of property sales can be displayed using the second graphical indicator, and those of the first set of property sales that are not included in the second set of property sales are displayed using a third graphical indicator.

Still further, the application is configured to automatically update an automated valuation for a subject property when the corresponding pool of property sales is updated according to the filtering criteria.

The comparable property analysis application 400 is preferably provided as software, but may alternatively be provided as hardware or firmware, or any combination of software, hardware and/or firmware. The application 400 is configured to provide the comparable property modeling, appraisal results comparing and corresponding mapping functionality described herein. Although one modular breakdown of the application 400 is offered, it should be understood that the same functionality may be provided using fewer, greater or differently named modules.

The example of the comparable property analysis application 400 of FIG. 4 includes a property data access module 402, AVM module 404, a property characteristics filtering module 406, appraisal information module 407, and UI module 408, with the UI module 408 further including a property and appraisal selection module 410, map image access module 412, indicator determining and rendering module 414 and property data grid/DB module 416.

The property data access module 402 includes program code for carrying access and management of the property data, whether from internal or external resources. The AVM module 404 includes program code for carrying out the regression upon the accessed property data, according to the regression algorithm described above, and produces corresponding results such as the determination of regression coefficients and other data at the country (or other) level as appropriate for a subject property. The AVM module 404 may implement any conventional code for carrying out the regression given the described explanatory variables and property data.

The property characteristics filtering module 406 is configured to apply default ranges for an initial pool of property sales. If desired, some exclusion rules may be applied to determine the initial pool of property sales. It is also configured to receive input with respect to updated ranges of property characteristics, so as to provide updates to the pool upon application of the new ranges. It is in communication with the UI module 408 so as to receive input with respect to the property characteristic ranges, and to provide updates in support of updated interfaces displayed by the UI module 408.

The appraisal information module 407 may be a stand-alone database or may organize access to a variety of external databases of appraisal information. The appraisal information is typically in the form of appraisal reports for subject properties, wherein a set of comparable properties chosen by an appraiser is listed. For example, when using this application, the appraisal information module 407 may store the results of appraisal activities of the user so that they may be subsequently retrieved. The appraisal information may be retrieved based upon a variety of criteria, including search by subject property, identification number, or characteristics (appraiser ID, vendor, date, etc.).

The UI module 408 manages the display and receipt of information to provide the described functionality. It includes a property and appraisal selection module 410, to manage the interfaces and input used to identify one or more subject properties and corresponding appraisal information. The map image access module 412 accesses mapping functions and manages the depiction of the map images as well as the indicators of the subject property and the pool of property sales as potential comparable properties. The indicator determination and rendering module 414 is configured to manage which indicators should be indicated on the map image depending upon the current map image, the rankable listing of the comparables and predetermined settings or user input. The property data grid/DB 416 manages the data set corresponding to a current session, including the subject property and pool of property sales. It is configured as a database that allows the property data for the properties to be displayed in a tabular or grid format, with various sorting according to the property characteristics, economic distance, geographical distance, time, etc.

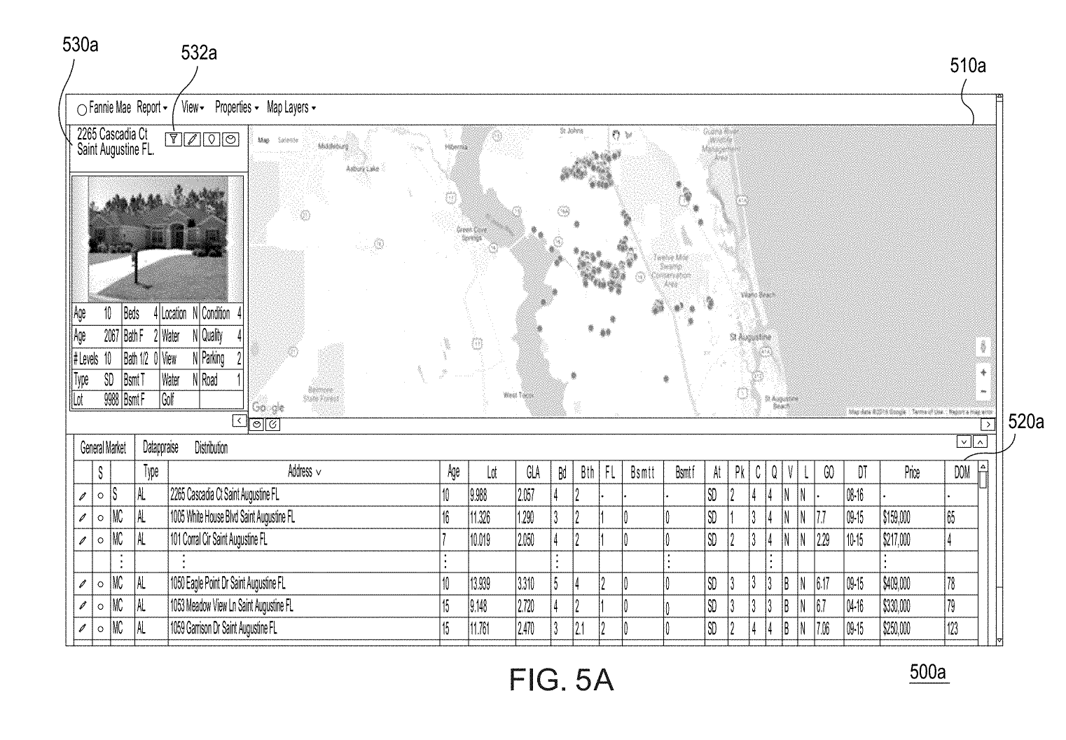

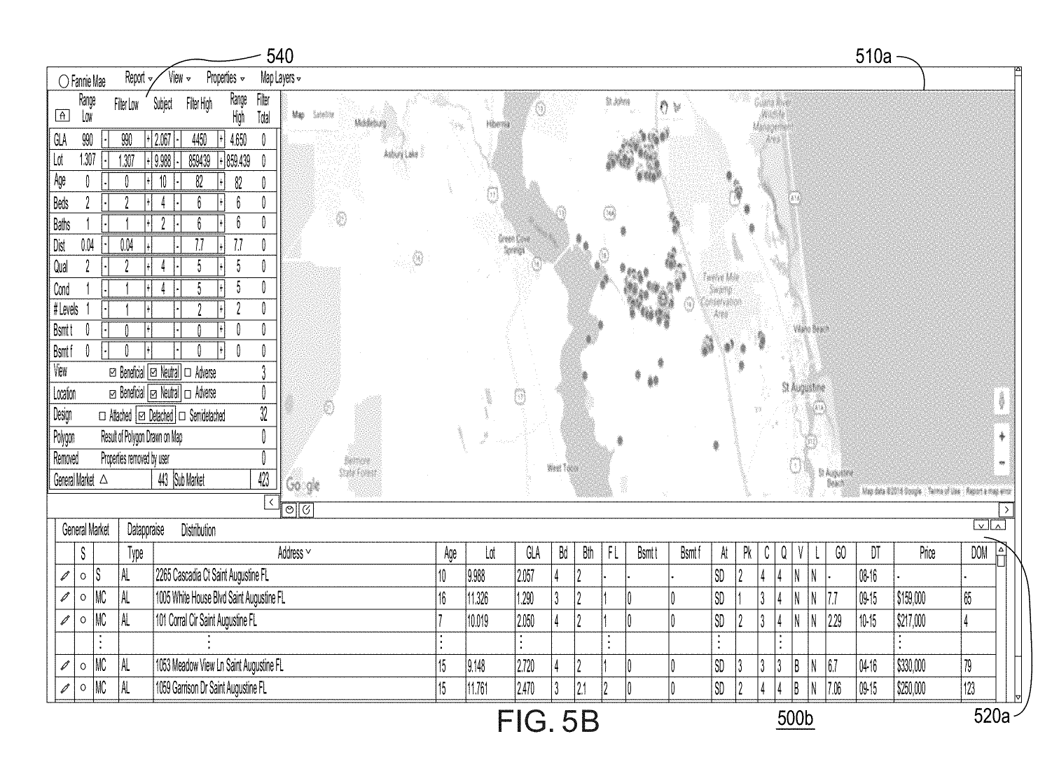

FIG. 5A is a display diagram 500a illustrating an example of a map image 510a and corresponding property grid data 520a for a list of property sales. The display diagram 500a also includes a region 530a depicting a currently selected subject property.

The property grid data 520a contains a listing of details about the subject property and the potential comparable properties, as well as various information fields. The fields include the address of the property (“Address”), the square footage (“GLA”), the lot size (“Lot”), the age of the property (“Age”), the number of bathrooms (“Bath”), the date of the prior sale (“Sale Age”), the prior sale amount (“Price”), and other information.

The list of potential comparable properties 520a, at least at the outset, is according to default property characteristics for defining the pool of property sales. In the subject property region 530a, a show-filters button 532a is preferably provided, which prompts the activation of the mode for updating the property characteristics that are used to define the pool of potential comparables.

FIG. 5B is an updated display 500b following the selection of the show-filters button 532a. The subject property region 530a is removed in favor of a listing of property characteristics 540 with corresponding ranges. For example, the property characteristics include GLA, Lot Size, Age, Bedrooms, Bathrooms, Distance, Quality Rating, Condition rating, Number of Levels, Basement Finished, and Basement Total. The user is also provided Low and High Range, the Subject Property's characteristics, and a Filter High and Filter Low, and filter total columns. The user can then use the Filter Low and Filter High Columns for each characteristic to adjust the shown recent sales based upon the changed characteristics.

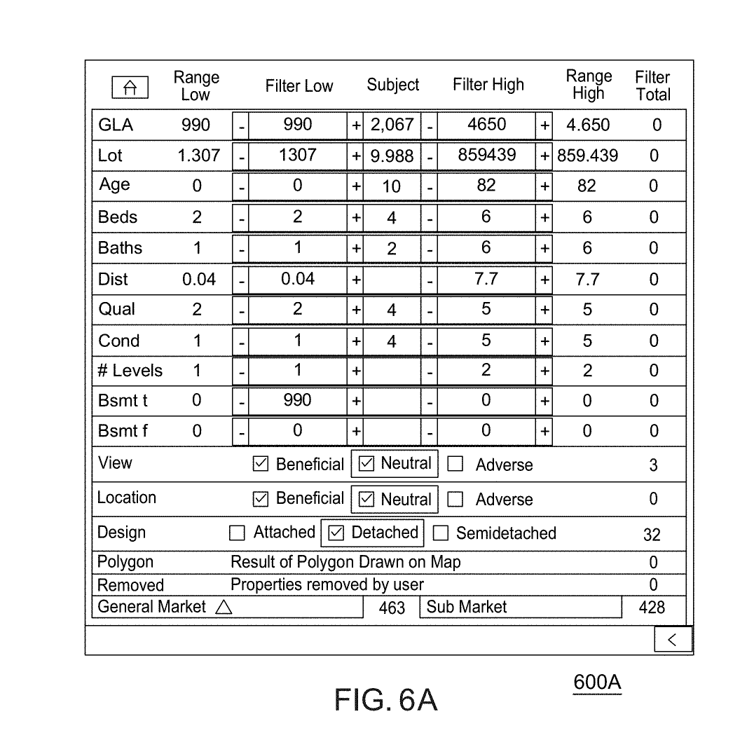

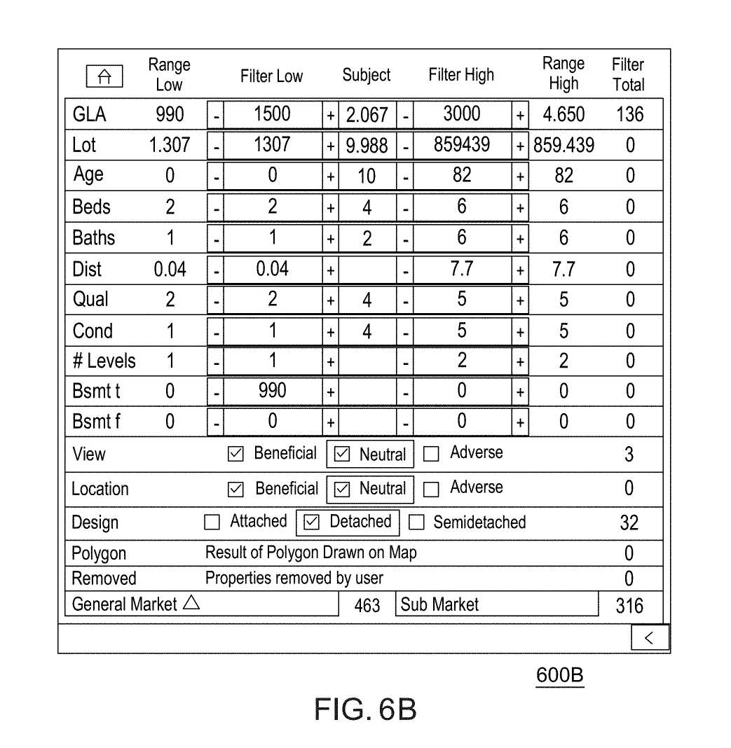

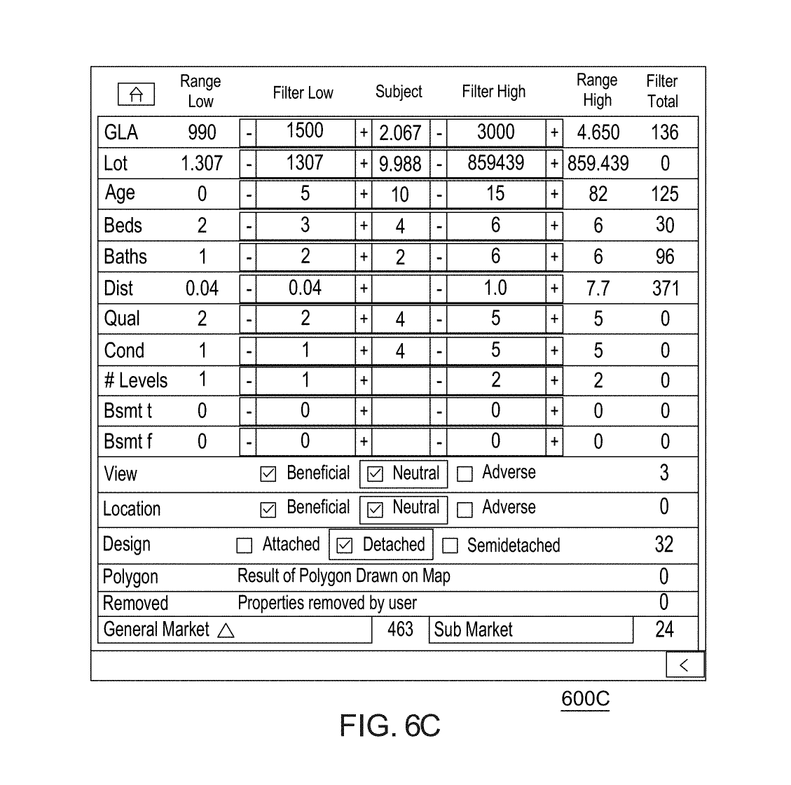

FIGS. 6A-C illustrate examples of the property characteristics filtering interface 600a-c. For example, FIG. 6A illustrates the interface 600a before using the filter low and high columns. The lower right corner of the interface 600a depicts the number of property sales in the pool according to the current settings, here 428 properties are in the pool of recent sales (“sub-market”). FIG. 6B illustrates the interface 600b after it has been updated to change the GLA range. Specifically, in FIG. 6A, the GLA range extends from 990 SF through 4650 SF, whereas the subject property is 2,067 SF. In FIG. 6B, the GLA range is changed from a filter low number of 1500 to a filter high number of 3000. The Sub Market is then indicated as 316 properties. FIG. 6C illustrates the interface 600c where the ranges for additional characteristics, namely age, number of bedrooms, number of bathrooms and distance from the subject property are updated. As illustrated, the number of properties in the sub-market at that point reduces to a 24 properties. In this fashion, the user is provided with a graphical indication of the market, along with depictions of the properties on the map image, and real time updates to the available pool of recent sales as the filters are manipulated.

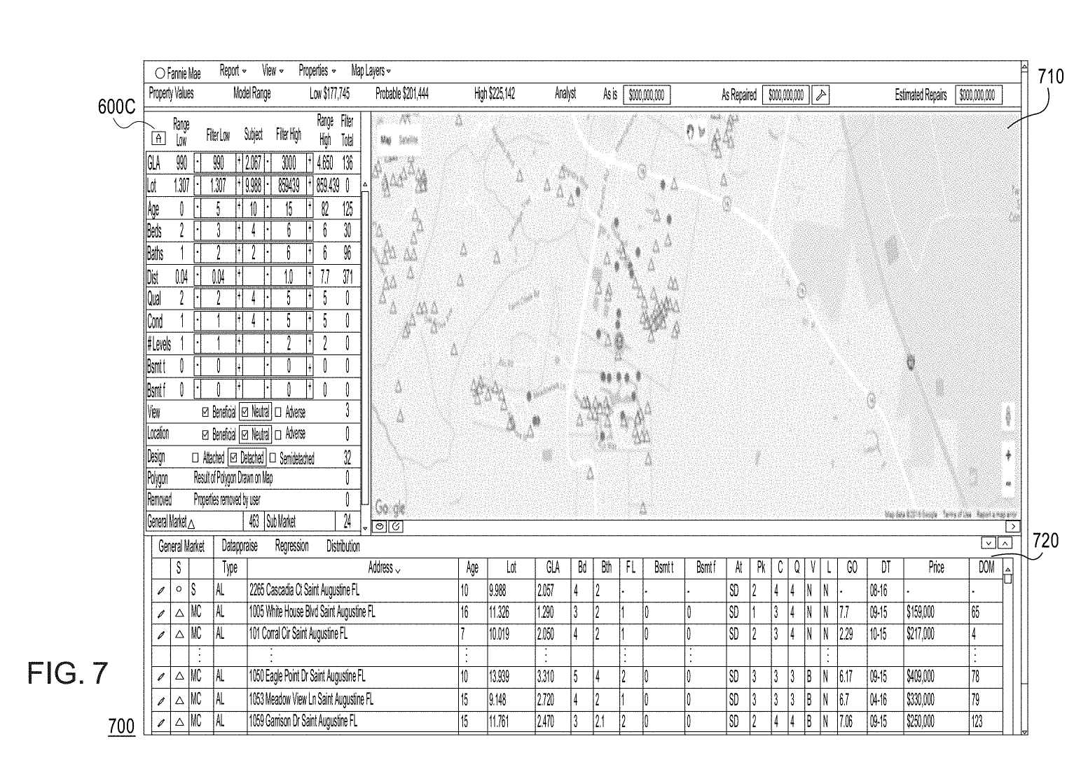

FIG. 7 is a display diagram having an updated display 700 following manipulation of the filters, particularly how the updated display 700 appears according to the filtering as shown in the interface 600c. The map image 700 automatically updates to depict the pool of recent sales that are included as solid dots, and those that are excluded as clear triangles. Additionally, the property grid data 720 updates to include only the included pool of recent sales. In this fashion, the user receives a clear depiction of the included properties alongside the more limited amount of comparables and their corresponding property data.

The map images depict geographical areas that can be manipulated to show a larger or smaller area, or moved to shift the center of the map image, in convention fashion. This allows the user to review the location of the subject property and corresponding comps at any desired level of granularity. This map image may be separately viewed on a full screen, or may be illustrated alongside the property data grid as shown.

Further assessment of the data can be variously undertaken by the user. The map image also allows the user to place a cursor over any of the illustrated properties to prompt highlighting of information for that property and other information. Additionally, the listing of comparables in the property grid data can be updated according to any of the listed columns. The grid data can be variously sorted to allow the user to review how the subject property compares to the listed potential comparable properties.

The user may variously update the map image and manipulate the property data grid in order to review and assess and subject property and the corresponding comparable properties in a fashion that is both flexible and comprehensive.

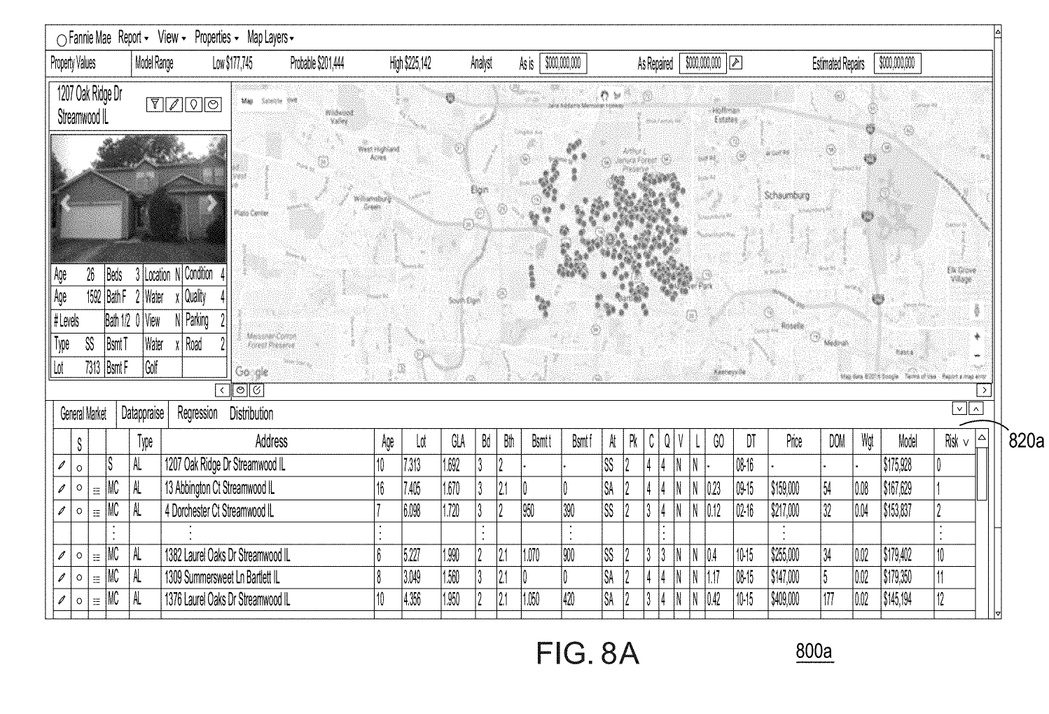

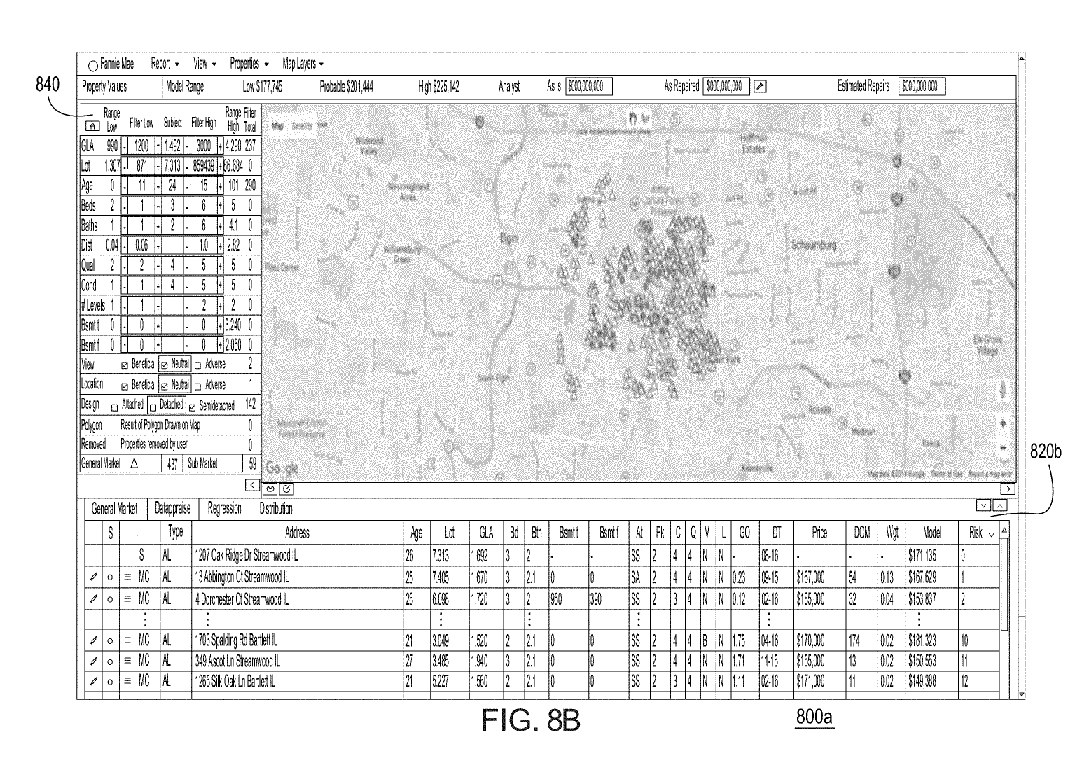

FIGS. 8A-B illustrate how the automated valuation of the subject property (i.e., the value determined by the model) updates when there are changes in the sub-market as a result of the property characteristics filtering operation. For example, FIG. 8A depicts a display 800a that includes a model-based valuation of $175,928 for the subject property in the property grid data 820a, under the default conditions (e.g., including all recent sales in the geographical area). FIG. 8B depicts the display 800b updated following application of filtering. As evident from the filtering interface 840, a submarket is created using homes with a GLA between 1,200 and 2,300 SF, an age between 18 and 35 years, and other filtered characteristics. The resulting sub-market produces a model-based valuation of $171,135 for the subject property. Specifically, the value updates as the weighted average of adjusted comps. As the sub-market is refined, the model-based valuation automatically updates to include a valuation using the adjusted values for each of the updated pool of recent sales. The adjustments and weighting are performed using the model as described above. If desired, the user can also choose any number of the properties from a current pool to obtain a corresponding weighted valuation from those properties. In this fashion, the user can apply narrowing of the pool and/or selection in order to see where further refinements in the comp pool stop causing significant changes in the subject property valuation.

Thus embodiments of the present invention produce and provide methods and apparatus for displaying property sales and automatically updating pools of comparables based upon filtered property characteristics. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for displaying a subject property along with pools of property sales, the method comprising:
receiving an identification of a subject property;
displaying a map image including a geographical area in which the subject property resides, the subject property being displayed within the geographical area using a first graphical indicator;
displaying a first set of property sales within the geographical area using a second graphical indicator that is distinct from the first graphical indicator;
receiving a request to filter the first set of property sales;
responsive to receiving the request, concurrently displaying a listing of property characteristics alongside the map image, the listing of property characteristics being configured to receive changes in ranges corresponding to the property characteristics;
receiving an altered range for at least one of the property characteristics from the listing of property characteristics; and
automatically updating the map image to display a second set of property sales that differs from the first set of property sales in response to receiving the altered range.

2. The method of claim 1, wherein the second set of property sales are displayed using the second graphical indicator, and those of the first set of property sales that are not included in the second set of property sales are displayed using a third graphical indicator.

3. The method of claim 1, wherein property characteristics information for a listing of property sales is concurrently displayed with the map image, the property characteristics information including an automated valuation of the subject property and each listed comparable property.

4. The method of claim 3, wherein upon receiving the altered range and updating the map image to display the second set of property sales, the automated valuation of the subject property automatically updates according to a new sub-market as defined according to the altered range and the corresponding second set of property sales.

5. The method of claim 2, wherein automatically updating the map image comprises changing the map image and geographical area to include each of the first indicator, the second indicators and the third indicators to concurrently depict the subject property, the currently appropriate pool of property sales, and the properties excluded from the pool of property sales.

6. The method of claim 3, wherein the automated valuation model performs a regression based upon property data, the regression modeling the relationship between price and explanatory variables, wherein the price is a dependent variable and the explanatory variables comprise the property characteristics.

7. A non-transitory computer readable medium storing program code for displaying a subject property along with pools of property sales, the program code being executable by a processor to perform operations comprising:
receiving an identification of a subject property;
displaying a map image including a geographical area in which the subject property resides, the subject property being displayed within the geographical area using a first graphical indicator;
displaying a first set of recent property sales as potential comparable properties within the geographical area using a second graphical indicator that is distinct from the first graphical indicator;
receiving a request to filter the first set of recent property sales;
responsive to receiving the request, concurrently displaying a listing of property characteristics alongside the map image, the listing of property characteristics being configured to receive changes in ranges corresponding to the property characteristics;
receiving an altered range for at least one of the property characteristics from the listing of property characteristics; and
automatically updating the map image to display a second set of recent property sales that differs from the first set of recent property sales in response to receiving the altered range.

8. The computer readable medium of claim 7, wherein the second set of property sales are displayed using the second graphical indicator, and those of the first set of property sales that are not included in the second set of property sales are displayed using a third graphical indicator.

9. The computer readable medium of claim 7, wherein property characteristics information for a listing of property sales is concurrently displayed with the map image, the property characteristics information including an automated valuation of the subject property and each listed comparable property.

10. The computer readable medium of claim 9, wherein upon receiving the altered range and updating the map image to display the second set of property sales, the automated valuation of the subject property automatically updates according to a new sub-market as defined according to the altered range and the corresponding second set of property sales.

11. The computer readable medium of claim 8, wherein automatically updating the map image comprises changing the map image and geographical area to include each of the first indicator, the second indicators and the third indicators to concurrently depict the subject property, the currently appropriate pool of property sales, and the properties excluded from the pool of property sales.

12. The computer readable medium of claim 9, wherein the automated valuation model performs a regression based upon property data, the regression modeling the relationship between price and explanatory variables, wherein the price is a dependent variable and the explanatory variables comprise the property characteristics.

13. An apparatus for displaying a subject property along with pools of property sales, the apparatus comprising:
a processor; and
a memory, the memory storing program code executable by the processor to perform operations comprising:
receiving an identification of a subject property;
displaying a map image including a geographical area in which the subject property resides, the subject property being displayed within the geographical area using a first graphical indicator;
displaying a first set of property sales within the geographical area using a second graphical indicator that is distinct from the first graphical indicator;
receiving a request to filter the first set of property sales;
responsive to receiving the request, concurrently displaying a listing of property characteristics alongside the map image, the listing of property characteristics being configured to receive changes in ranges corresponding to the property characteristics;
receiving an altered range for at least one of the property characteristics from the listing of property characteristics; and
automatically updating the map image to display a second set of property sales that differs from the first set of property sales in response to receiving the altered range.

14. The apparatus of claim 13, wherein the second set of property sales are displayed using the second graphical indicator, and those of the first set of property sales that are not included in the second set of property sales are displayed using a third graphical indicator.

15. The apparatus of claim 13, wherein property characteristics information for a listing of property sales is concurrently displayed with the map image, the property characteristics information including an automated valuation of the subject property and each listed comparable property.

16. The apparatus of claim 15, wherein upon receiving the altered range and updating the map image to display the second set of property sales, the automated valuation of the subject property automatically updates according to a new sub-market as defined according to the altered range and the corresponding second set of property sales.

17. The apparatus of claim 14, wherein automatically updating the map image comprises changing the map image and geographical area to include each of the first indicator, the second indicators and the third indicators to concurrently depict the subject property, the currently appropriate pool of property sales, and the properties excluded from the pool of property sales.

18. The apparatus of claim 15, wherein the automated valuation model performs a regression based upon property data, the regression modeling the relationship between price and explanatory variables, wherein the price is a dependent variable and the explanatory variables comprise the property characteristics.
